(19) United States
(12) Patent Application Publication
(10) Pub. No.: US 2008/0225441 A1
(43) Pub. Date: Sep. 18, 2008

(54) MAGNETIC HEAD

(75) Inventors: Hiroyuki Yamada, Kawasaki (JP); Hirofumi Nagai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/031,150

(22) Filed: Feb. 14, 2008

(30) Foreign Application Priority Data
Mar. 16, 2007 (JP) 2007-069561

(51) Int. Cl. G11B 5/33

(52) U.S. Cl. 360/319

(57) ABSTRACT

According to an embodiment of the present invention, a magnetic head for recording information on a recording medium comprises a magnetic pole layer having an end face to be facing the recording medium; an auxiliary magnetic pole layer magnetically connected to the magnetic pole; and a shield layer for shielding the magnetic pole layer from an external magnetic field, the shield layer having a first surface to be facing the recording medium, a second surface to be facing the recording medium adjacent to the first surface, and a third surface adjacent to the second surface, the first surface and the second surface forming an acute external angle, the first surface and the third surface forming an obtuse external angle.

### BACKGROUND OF THE INVENTION

The present invention relates to a magnetic head for performing a magnetic recording operation using a perpendicular magnetic recording method or a magnetic head for reading out recorded data from a recording medium using a perpendicular magnetic recording method and performing a data reproducing operation.

### SUMMARY

According to an embodiment of the present invention, a magnetic head for recording information on a recording medium comprises a magnetic pole layer having an end face to be facing the recording medium; an auxiliary magnetic pole layer magnetically connected to the magnetic pole; and a shield layer for shielding the magnetic pole layer from an external magnetic field, the shield layer having a first surface to be facing the recording medium, a second surface to be facing the recording medium adjacent to the first surface, and a third surface adjacent to the second surface, the first surface and the second surface forming an acute external angle, the first surface and the third surface forming an obtuse external angle.

According to another embodiment of the present invention, a magnetic head for reproducing information recorded on a recording medium comprises a magneto-resistive element for reproducing information, and a shield layer for shielding the magneto-resistive element from an external magnetic field, the shield layer having a first surface to be facing the recording medium, a second surface to be facing the recording medium adjacent to the first surface, and a third surface adjacent to the second surface, the first surface and the second surface forming an acute external angle, the first surface and the third surface forming an obtuse external angle.

According to still another embodiment of the present invention, a magnetic head for recording information on a recording medium comprises a magnetic pole layer having an end face to be facing the recording medium; an auxiliary magnetic pole layer magnetically connected to the magnetic pole, the auxiliary magnetic pole layer having a first surface to be facing the recording medium, a second surface to be facing the recording medium adjacent to the first surface, and a third surface adjacent to the second surface, the first surface and the second surface forming an acute external angle, the first surface and the third surface forming an obtuse external angle.

### BRIEF DESCRIPTION OF THE DRAWINGS

FIG. 1 is a schematic cross-sectional view of a magnetic head according to an embodiment of the present invention, which is cut by a plane perpendicular to a diametrical direction of a recording medium;

FIG. 2 is a schematic illustration of a shield layer and an auxiliary magnetic pole layer of a magnetic head according to the present invention when viewed in a direction in which the layers are stacked on a substrate;

FIGS. 3A and 3B are schematic illustrations of the shape of a reproducing head unit of a magnetic head according to an embodiment of the present invention;

FIG. 4 is a partial schematic illustration of the shape of a recording head unit of a magnetic head viewed from the diametrical direction of a recording medium according to an embodiment of the present invention;

FIG. 5 is a partial schematic, illustration of the shape of the recording head unit of a magnetic head viewed from the diametrical direction of a recording medium according to an embodiment of the present invention;

FIG. 6 is a partial schematic illustration of the shape of the recording head unit of a magnetic head viewed from the diametrical direction of a recording medium according to an embodiment of the present invention;

FIG. 7 is a partial schematic illustration of the shape of the recording head unit of a magnetic head viewed from the diametrical direction of a recording medium according to an embodiment of the present invention;

FIG. 8 illustrates a simulation result relating to a magnetic field intensity ratio at a corner A_{R} when the external angle θ_{AR}=θ_{AL}=13° and the external angle θ_{BR} (=θ_{BL}) is changed;

FIG. 9 illustrates a simulation result relating to a magnetic field intensity ratio at a corner A_{R} when the external angle θ_{BR}=θ_{BL}=110° and the external angle θ_{AR} (=θ_{AL}) is changed;

FIGS. 10A to 10D are schematic illustrations of modifications of a shield of a magnetic head when viewed from a layer direction of a substrate, according to the present invention; and

FIG. 11 is a schematic illustration of a shield layer of a magnetic head when viewed from a layer direction of a substrate, according to the present invention.

### DESCRIPTION OF THE PREFERRED EMBODIMENTS

In recent years, a hard disk drive (HDD) magnetic heads using a perpendicular magnetic recording method have been developed. These HDD magnetic heads have a higher surface recording density than that of HDD magnetic heads using a longitudinal magnetic recording method.

Some HDD magnetic heads using a perpendicular magnetic recording method have a single magnetic pole structure including a main magnetic pole layer, an auxiliary magnetic pole layer, and an excitation coil that acts on these layers. On the other hand, some magnetic disks serving as recording media have a laminated structure including a soft magnetic underlayer (SUL) that serves as a part of a magnetic circuit and a perpendicular magnetic recording layer. In a perpendicular magnetic recording method, a demagnetizing field in a magnetic transition region of a surface of a magnetic disk is significantly reduced, as compared with that of a longitudinal magnetic recording method. Accordingly, the magnetic transition width can be reduced. In addition, in a longitudinal magnetic recording method, magnetization of a recording medium is easily influenced by a heat change when high-density recording is performed. However, in a perpendicular magnetic recording method, the magnetization is insensitive to the heat change. Thus, even when high-density recording is performed, stable recording can be obtained. Data recorded on a recording medium using the perpendicular magnetic recording method can be read by a reproducing head including an existing magnetoresistance (MR) element, such as an anisotropic magnetoresistance (AMR) element, a giant magnetoresistance (GMR) element, or a tunnel magnetoresistance (TMR) element.

For magnetic recording apparatuses using a perpendicular magnetic recording method, a magnetic field unintentionally applied from outside the casing or the presence of a stray magnetic field inside the apparatuses may cause magnetized recorded information to deteriorate, thereby causing a critical problem when the apparatuses are used.

One of such problems is an edge writing problem. Edge writing is a phenomenon in which information recorded on a recording medium is erased by a magnetic field concentrated from the soft magnetic underlayer onto an auxiliary magnetic pole or an end of a shield due to a stray field occurring in a magnetic head apparatus.

As used herein, the term “shield” refers to both a shield provided to a reproducing head and a shield provided to a recording head. The shield provided to a reproducing head reduces an influence of an external magnetic field on an MR element and stabilizes the read characteristic. In general, two shields are disposed so as to sandwich an MR element. In contrast, the shield provided to a recording head reduces an influence of an external magnetic field on a main magnetic pole layer and stabilizes the recording characteristic. An example of such a shield is a trailing shield provided on the top end of the auxiliary magnetic pole on a floating surface side and separated from a main magnetic pole by a predetermined distance. Another example of such a shield is a write shield provided on a surface opposite a surface of the main magnetic pole layer facing the auxiliary pole and separated from the main magnetic pole layer by a predetermined distance.

Accordingly, it is an object of the present invention to provide a magnetic head that reduces edge writing on a recording medium.

Exemplary embodiments of the present invention are described in detail below with reference to the accompanying drawings.

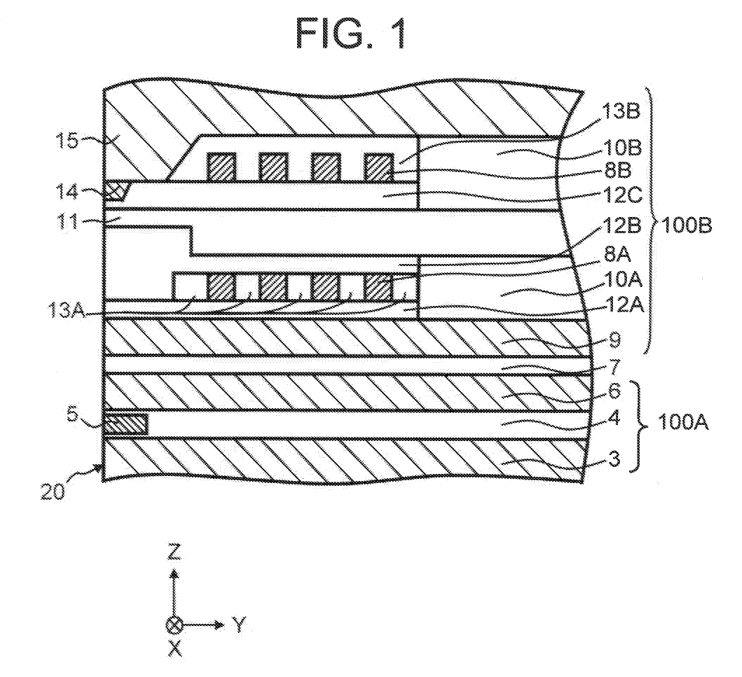

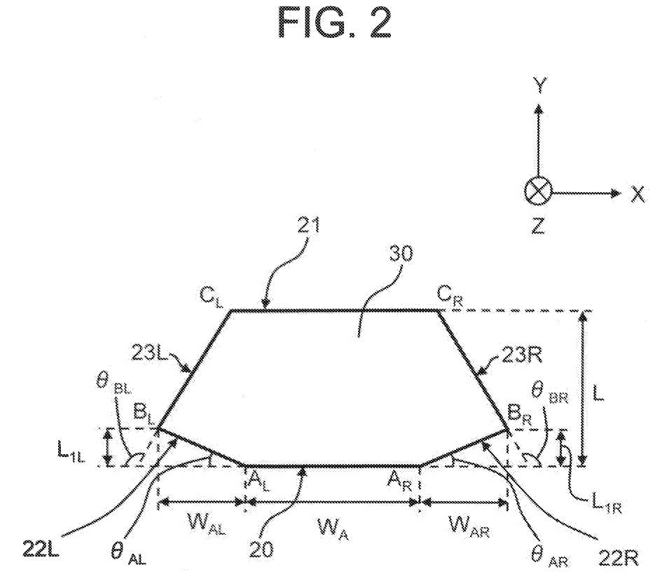

An exemplary structure of a magnetic head according to an embodiment of the present invention is described first with reference to FIG. 1. In the following description, an X-axis direction represents a diametrical direction of a recording medium, a Y-axis direction represents a direction extending away from the recording medium, and a Z-axis direction represents a direction in which layers are stacked on a substrate (hereinafter referred to as a “layer direction of the substrate”). The Z-axis direction also represents a moving direction of the recording medium relative to the magnetic head. The X-axis direction, the Y-axis direction, and the Z-axis direction are perpendicular to each other. In addition, a distance in the X-axis direction is referred to as a “width”. A distance in the Y-axis direction is referred to as a “length”. A distance in the Z-axis direction is referred to as a “thickness”. Furthermore, a side adjacent to a floating surface (an air-bearing surface) is referred to as a “floating surface side”. The side opposite the floating surface side is referred to as a “height side”. These representations are also applied to descriptions subsequent to FIG. 2 given below.

FIG. 1 is a cross-sectional view of a magnetic head cut by a plane perpendicular to a diametrical direction of a recording medium. According to the present embodiment, a magnetic head serves as a magnetic recording device mounted in a magnetic recording apparatus, such as a hard disk drive. For example, the magnetic head is a combination head capable of providing both recording and reproducing functions. For example, the magnetic head includes a substrate (not shown) made of a ceramic material, such as altic (Al₂O₃TiC). The following layers are stacked on the substrate in this order: an insulating layer (not shown) formed from aluminum oxide (Al₂O₃, hereinafter simply referred to as “alumina”), a reproducing head unit 100A for performing a reproducing operation using magnetic resistance (MR), a recording head unit 100B for performing a recording operation using a perpendicular recording method, and an overcoat layer (not shown) made of, for example, alumina. However, in a magnetic head according to the present invention, an insulating layer, a reproducing head unit, and an overcoat layer may be stacked on a substrate in this order. Alternatively, in a magnetic head according to the present invention, an insulating layer, a recording head unit, and an overcoat layer may be stacked on a substrate in this order.

For example, the reproducing head unit 100A includes a lower shield layer 3, a gap film 4, and an upper shield layer 6 layered in this order. The gap film 4 incorporates an MR element 5 functioning as a magnetic reproducing device so that one end surface of the MR element 5 is exposed through a floating surface 20.

The lower shield layer 3 and the upper shield layer 6 magnetically shield the MR element 5 from the surrounding environment. The lower shield layer 3 and the upper shield layer 6 are made of a magnetic material, such as nickel-iron alloy (NiFe, hereinafter simply referred to as “permalloy” (trade name)). The permalloy contains 80 wt % Ni and 20 wt % Fe. The thickness of each of the lower shield layer 3 and the upper shield layer 6 is in the range of about 1.0 μm to about 2.0 μm.

The gap film 4 magnetically and electrically separates the MR element 5 from the lower shield layer 3 and the upper shield layer 6. The gap film 4 is made of a non-magnetic and non-conductive material, such as alumina. The thickness of the gap film 4 is in the range of about 0.1 μm to about 0.2 μm.

The MR element 5 performs a reproducing process using, for example, a giant magnetoresistive (GMR) effect or a tunneling magnetoresistive (TMR) effect.

The recording head unit 100B includes, for example, the following layers: a return yoke layer 9, a resist layer 13A incorporating a coil 8A therein, a non-magnetic layer 12A, a non-magnetic layer 12B, a main magnetic pole layer 11 magnetically connected to the return yoke layer 9 via a connection layer 10A, a resist layer 13B incorporating a coil 8B therein, a non-magnetic layer 12C, a return yoke layer 15 magnetically connected to the main magnetic pole layer 11 via a connection layer 10B, and a trailing shield layer 14. The trailing shield layer 14 is disposed on the return yoke layer 15 on the floating surface side. In addition, the trailing shield layer 14 faces a surface of the main magnetic pole layer 11 on a trailing side with the non-magnetic layer 12C therebetween.

The return yoke layers 9 and 15 of the recording head unit 100B cause the magnetic flux emanating from the main magnetic pole layer 11 to return to the main magnetic pole layer 11 through a hard disk (not shown). The return yoke layers 9 and 15 are formed from, a magnetic material, such as permalloy (Ni: 80 wt %, Fe: 20 wt %). The thickness of each of the return yoke layers 9 and 15 is in the range of about 1.0 μm to about 4.0 μm. The return yoke layers 9 and 15 are an example of an “auxiliary magnetic pole layer” of the present invention.

The non-magnetic layers 12A, 12B, and 12C are formed from a non-magnetic and non-conductive material, such as alumina or silicon oxide (SiO₂). The thickness of each of the non-magnetic layers 12A, 12B, and 12C is in the range of about 0.1 μm to about 1.0 μm.

The resist layers 13A and 13B are formed from, for example, a photoresist (a photosensitive resin). A photoresist becomes fluid when heated.

The coils 8A and 8B primarily generate a magnetic flux for recording. The coils 8A and 8B are formed from a highly conducting material, such as copper (Cu).

The connection layers 10A and 10B are used for magnetically connecting the return yoke layers 9 and 15 to the main magnetic pole layer 11. The connection layers 10A and 10B are formed from a magnetic material, such as permalloy (Ni: 80 wt %, Fe: 20 wt %).

The main magnetic pole layer 11 primarily receives a magnetic flux generated by the coils 8A and 8B and emits the magnetic flux to a hard disk (not shown). The main magnetic pole layer 11 is formed from, for example, an iron-cobalt alloy (FeCo), an iron-based alloy (Fe-M, where M is a metal element of groups 4A, 5A, 6A, 3B, or 4B), or a nitride of these alloys. The thickness of the main magnetic pole layer 11 is in the range of about 0.1 μm to about 0.5 μm.

The trailing shield layer 14 primarily increases a magnetic field gradient of a write magnetic field in the main magnetic pole layer when a magnetic flux emanating from the main magnetic pole layer 11 returns to the return yoke layer 9 through a hard disk (not shown). In addition, the trailing shield layer 14 magnetically shields the main magnetic pole layer 11 from a surrounding environment. The trailing shield layer 14 is formed from a magnetic material, such as permalloy (Ni: 80 wt %, Fe: 20 wt %). The thickness of the trailing shield layer 14 is in the range of about 1.0 μm to about 2.0 μm. The trailing shield layer 14 is an example of a “shield layer” of the present invention.

The above-described layers can be fabricated by sequentially layering the upper layers onto the lower layer on a ceramic substrate (not shown) illustrated in FIG. 1 using a film-forming technology, such as plating or sputtering, a patterning technology, such as a photolithography method or an etching method, and an existing thin-film process including a polishing technology, such as a machining process and a polishing process.

An exemplary structure of the main part of the magnetic head is described in detail next with reference to FIGS. 2 to 7 and FIG. 11.

FIG. 2 is a schematic illustration of the shield layer and the auxiliary magnetic pole layer of a magnetic head according to the present invention when viewed in a direction in which layers are stacked on a substrate. Hereinafter, the shield layer and the auxiliary magnetic pole layer are also collectively referred to “shield layers”.

As shown in FIG. 2, when the shield layers are viewed in a direction in which layers are stacked on a substrate, the shield layers have a two-stage tapered shape. The shield layers have a floating surface 20 that faces a recording medium, tapered surfaces 22L and 22R that face the recording medium, and tapered surfaces 23L and 23R that do not face the recording medium. The surface 20 is disposed so as to be adjacent to the surface 22L. In addition, the surface 20 is disposed so as to be adjacent to the surface 22R. The surface 22L is disposed so as to be adjacent to the surface 23L. The surface 22R is disposed so as to be adjacent to the surface 23R. Thus, corners A_{L}, A_{R}, B_{L}, and B_{R} are formed.

A height surface 21 is disposed on a height side of the shield layers so as to be parallel to the surface 20. The surface 21 is disposed so as to be adjacent to the surface 23L. In addition, the surface 21 is disposed so as to be adjacent to the surface 23R. Thus, corners C_{L} and C_{R} are formed.

Each of an external angle θ_{AL} formed by the surface 20 and the surface 22L and an external angle θ_{AR} formed by the surface 20 and the surface 22R is an acute angle. In contrast, each of an external angle θ_{BL} formed by the surface 20 and the surface 23L and an external angle θ_{BR} formed by the surface 20 and the surface 23R is an obtuse angle.

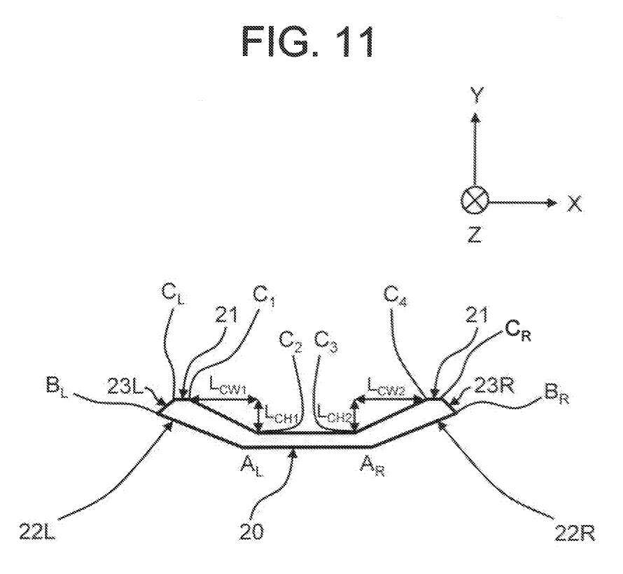

As shown in FIG. 11, a surface between the corners C_{L} and C_{R} may include a concave portion represented by a corner C₁-a corner C₂-a corner C₃-a corner C₄.

The shield layers having such a shape have an angle A_{L}B_{L}C_{L} and an angle A_{R}B_{R}C_{R} sharper than those of an existing shield layers that have a single tapered shape. Accordingly, the shield layers can concentrate a magnetic flux on the corners and prevent the magnetic flux from being concentrated on the vicinity of the corners A_{L} and A_{R} that are located near the floating surface 20. Since the magnetic flux is not concentrated on the vicinity of the corners A_{L} and A_{R}, the occurrence of the edge writing problem of the magnetic head can be significantly reduced.

Here, the floating surface 20 is an example of a “first surface” of the shield layer or a “first surface” of the auxiliary magnetic pole layer of the present invention. Each of the tapered surfaces 22L and 22R that face a recording medium is an example of a “second surface” of the shield layer or a “second surface” of the auxiliary magnetic pole layer of the present invention. In addition, each of the tapered surfaces 23L and 23R that does not face the recording medium is an example of a “third surface” of the shield layer or a “third surface” of the auxiliary magnetic pole layer of the present invention.

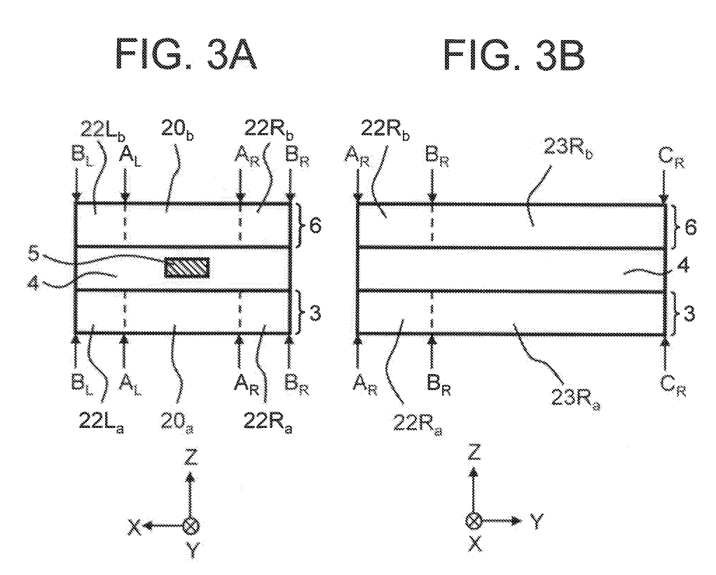

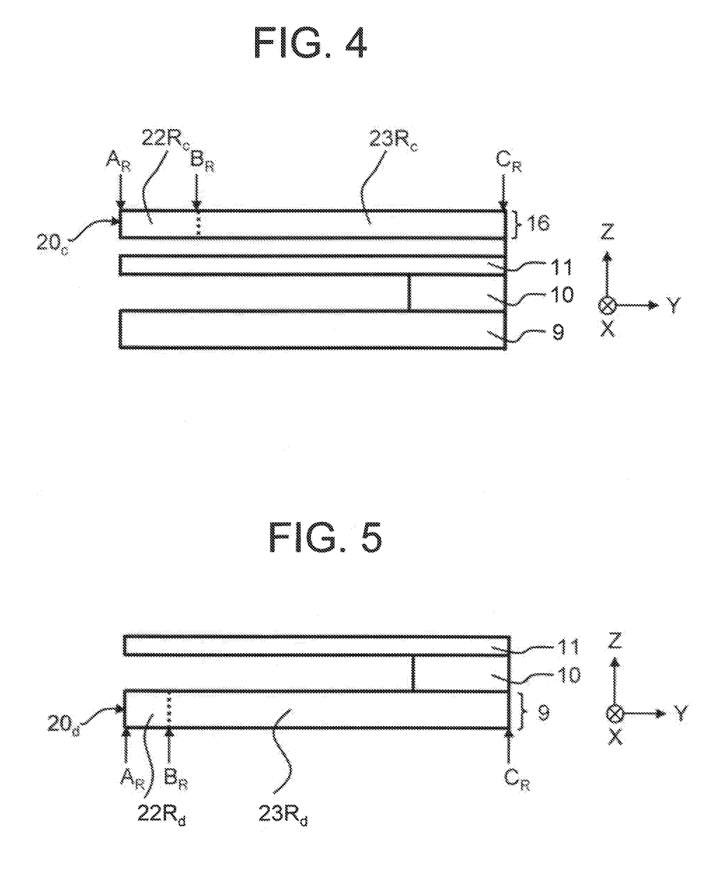

FIG. 3A is a schematic illustration of a portion of a reproducing head unit of a magnetic head viewed from the floating surface side according to an embodiment of the present invention. FIG. 3B is a schematic illustration of a portion of the reproducing head unit viewed from the diametrical direction of a recording medium according to the embodiment of the present invention. For simplicity, a coil, a non-magnetic layer, and a resist layer are not shown in the drawings (this is the same for FIGS. 4 to 7). The reproducing head unit includes the lower shield layer 3 and the upper shield layer 6 having the shapes illustrated in FIG. 2 with the gap film 4 therebetween. The gap film 4 has the MR element 5 mounted on a floating surface side. The lower shield layer 3 and the upper shield layer 6 surround the MR element 5 so as to magnetically shield the MR element 5 from the surrounding environment.

The lower shield layer 3 and the upper shield layer 6 can cause a magnetic flux to be concentrated on the corners B_{L} and B_{R}, and therefore, the lower shield layer 3 and the upper shield layer 6 can prevent the magnetic flux from being concentrated on the corners A_{L} and A_{R} that are the closest to the counter surface of the recording medium. Accordingly, a magnetic flux that is concentrated on the corner A_{L} and A_{R} and the vicinity of the corners A_{L} and A_{R} from the soft magnetic underlayer of the recording medium is reduced. Thus, the edge writing problem in which the magnetic flux erases information stored on the recording medium is solved. Here, each of floating surfaces 20a and 20b is an example of a “first surface” of the shield layers of the present invention. Each of tapered surfaces 22Rₐ, 22Lₐ, 22R_{b}, and 22L_{b} is an example of a “second surface” of the shield layers of the present invention. In addition, each of tapered surfaces 23Rₐ and 23R_{b} and tapered surfaces (not shown) adjacent to the height sides of the tapered surfaces 22Lₐ and 22L_{b} is an example of a “third surface” of the shield layers of the present invention.

FIG. 4 is a partial schematic illustration of the shape of the recording head unit of a magnetic head viewed from the diametrical direction of a recording medium according to an embodiment of the present invention. The magnetic head includes a write shield layer 16. In the magnetic head, the main magnetic pole layer 11 is magnetically connected to the return yoke layer 9 with a connection layer 10 therebetween. The write shield layer 16 is disposed on the side of the main magnetic pole layer 11 opposite the return yoke layer 9. The write shield layer 16 is not magnetically connected to the main magnetic pole layer 11. When viewed from a direction in which the layers are stacked on the substrate, the write shield layer 16 has a shape as illustrated in FIG. 2. Here, a floating surface 20c is an example of a “first surface” of the shield layers of the present invention. A tapered surface 22R_{c} is an example of a “second surface” of the shield layers of the present invention. In addition, a tapered surface 23R_{c} is an example of a “third surface” of the shield layers of the present invention.

FIG. 5 is a partial schematic illustration of the shape of the recording head unit of a magnetic head viewed from the diametrical direction of a recording medium according to an embodiment of the present invention. In the magnetic head, a main magnetic pole layer 11 is magnetically connected to a return yoke layer 9 with a connection layer 10 therebetween. When viewed from the direction in which the layers are stacked on the substrate, the return yoke layer 9 has a shape as illustrated in FIG. 2. Here, a floating surface 20d is an example of a “first surface” of the auxiliary magnetic pole layer of the present invention. A tapered surface 22R_{d} is an example of a “second surface” of the auxiliary magnetic pole layer of the present invention. In addition, a tapered surface 23R_{d} is an example of a “third surface” of the auxiliary magnetic pole layer of the present invention.

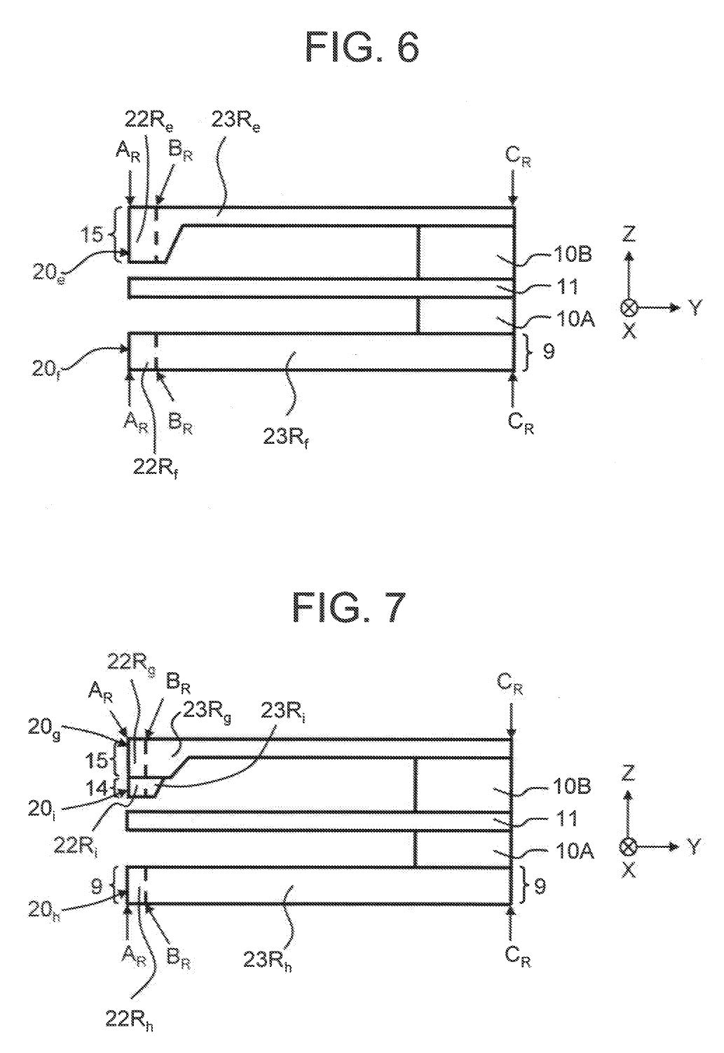

FIG. 6 is a schematic illustration of the shape of a portion of the recording head unit of a magnetic head viewed from the diametrical direction of a recording medium according to an embodiment of the present invention. This magnetic head has a structure similar to that of the magnetic head illustrated in FIG. 5 except that a return yoke layer 15 is provided on the side of the main magnetic pole layer 11 opposite the return yoke layer 9 and is magnetically connected to the main magnetic pole layer 11. When viewed from a direction in which the layers are stacked on the substrate, each of the return yoke layer 9 and a return yoke layer 15 has a shape as illustrated in FIG. 2. Here, each of floating surfaces 20e and 20f is an example of a “first surface” of the auxiliary magnetic pole layer of the present invention. Each of tapered surfaces 22Rₑ and 22R_{f} is an example of a “second surface” of the auxiliary magnetic pole layer of the present invention. In addition, each of tapered surface 23Rₑ and 23R_{f} is an example of a “third surface” of the auxiliary magnetic pole layer of the present invention.

FIG. 7 is a schematic illustration of the shape of a portion of the recording head unit of a magnetic head viewed from the diametrical direction of a recording medium according to an embodiment of the present invention. This magnetic head has a structure similar to that of the magnetic head illustrated in FIG. 6 except that a trailing shield layer 14 is provided on a top end of a floating surface of the return yoke layer 15 with a predetermined spacing between the trailing shield layer 14 and a main pole. When viewed from a direction in which the layers are stacked on the substrate, each of return yoke layers 9 and 15 and the trailing shield layer 14 has a shape as illustrated in FIG. 2. Here, each of floating surfaces 20g and 20h is an example of a “first surface” of the auxiliary magnetic pole layer of the present invention. Each of tapered surfaces 22R_{g} and 22Rₕ is an example of a “second surface” of the auxiliary magnetic pole layer of the present invention. In addition, each of tapered surface 23R_{g} and 23Rₕ is an example of a “third surface” of the auxiliary magnetic pole layer of the present invention.

Furthermore, a floating surface 20i is an example of shield layers of the auxiliary magnetic pole layer of the present invention. A tapered surface 22Rᵢ is an example of a “second surface” of the shield layers of the present invention. Still furthermore, a tapered surface 23Rᵢ is an example of a “third surface” of the shield layers of the present invention.

To solve the edge writing problem in the case where the magnetic head according to the present invention includes a plurality of the shield layers or a plurality of the auxiliary magnetic pole layers, it is desirable that all of the shield layers or all of the auxiliary magnetic pole layers have the shape as illustrated in FIG. 2 when viewed from a direction in which the layers are stacked on the substrate.

The shape of the shield layers of the magnetic head is described in more detail next with reference to FIG. 2.

It is desirable that each of an inner angle A_{R}B_{R}C_{R} formed by the tapered surfaces 22R and 23R and an inner angle A_{L}B_{L}C_{L} formed by the tapered surfaces 22L and 23L is an acute angle. By disposing the corners having an acute angle so as to be distant from the floating surface of the shield layer, the magnetic flux can be concentrated on the corners having an acute angle, and therefore, the magnetic flux is not concentrated on the corners in the vicinity of the floating surface. In such a magnetic head, the occurrence of the edge writing problem can be reduced. The inner angle A_{R}B_{R}C_{R} may be the same as or different from the inner angle A_{L}B_{L}C_{L}.

In particular, it is desirable that each of the external angle θ_{AR} formed by the tapered surface 22R and the floating surface 20 and the external angle θ_{AL} formed by the tapered surface 22L and the floating surface 20 is in the range of 3° to 15°, and each of the external angle θ_{BR} formed by the tapered surface 22R and the floating surface 20 and the external angle θ_{BL} formed by the tapered surface 22L and the floating surface 20 is in the range of 105° to 135°. Hereinafter, the external angles θ_{AR} and θ_{AL} are also collectively referred to as an “external angle θ_{A}”, and the external angles θ_{BR} and ν_{BL} are also collectively referred to as an “external angle θ_{B}”. The external angle θ_{AR} may be the same as or different from the external angle θ_{AL}. In addition, the external angle θ_{BR} may be the same as or different from the external angle θ_{BL}.

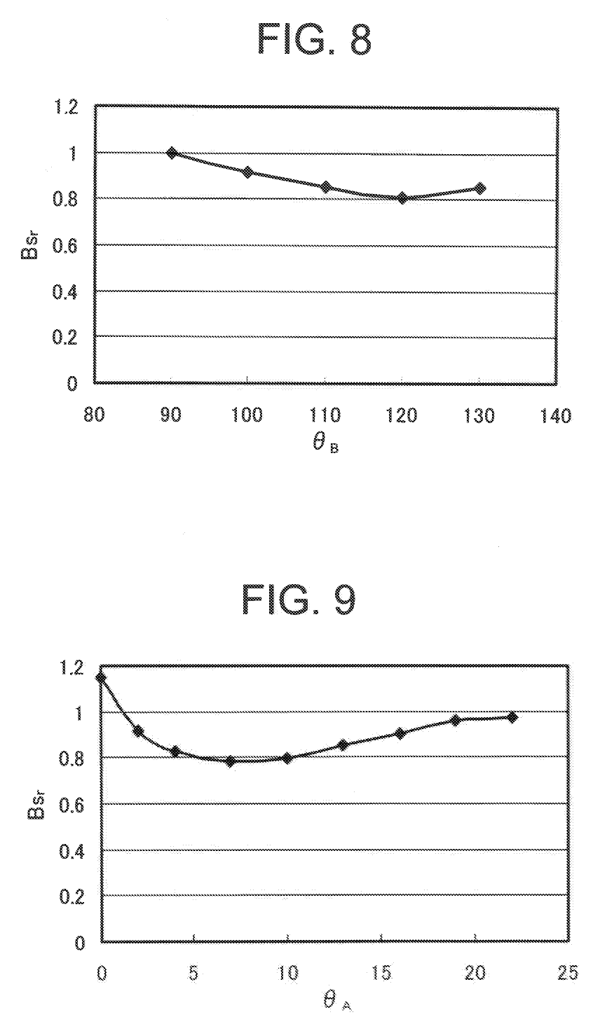

FIGS. 8 and 9 illustrate results of simulation performed for the magnetic head illustrated in FIG. 1 including the reproducing head unit. Illustrated in FIGS. 3A and 3B and the recording head unit illustrated in FIG. 7. In the simulation, a magnetic field intensity ratio B_{Sr} at a portion corresponding to the corner A_{R} of the return yoke layer 9 or 15 or the trailing shield layer 14 was obtained when the external, angles θ_{A} and θ_{B} of the return yoke layer 9 or 15 or the trailing shield layer 14 were changed. At that time, the external angles θ_{A} and θ_{B} of the return yoke layer 9 and 15 and the trailing shield layer 14 were under the same condition.

Here, the magnetic field intensity ratio B_{Sr} is a ratio of a leakage magnetic field intensity to a leakage magnetic field intensity (unit: Oe) at the portion corresponding to the corner A_{R} when a constant magnetic field is applied to a recording medium in the perpendicular direction using a magnetic head having a reproducing head unit including a shield layer having an external angle θ_{A} of 13° and an external angle θ_{B} of 90°. Note that a maximum leakage magnetic field intensity (unit: Oe) is selected at the portion corresponding to the corner A_{R} when the angles are changed.

FIG. 8 is a graph illustrating the magnetic field intensity ratio B_{Sr} when the external angle θ_{A}=13° and the external angle θ_{B} is changed.

The leakage magnetic field intensity of the shield layer having an external angle θ_{B} of 105° to 135° is reduced by an amount more than or equal to 10% as compared with the leakage magnetic field intensity of a shield layer having an external angle θ_{B} of 90°, that is, a one-stage tapered shield layer. The leakage magnetic field intensity of the shield layer having an external angle θ_{B} of 115° to 135° is reduced by an amount more than or equal to 15% as compared with the leakage magnetic field intensity of a one-stage tapered shield layer. In particular, the leakage magnetic field intensity of the shield layer having an external angle θ_{B} of 118° to 122° is reduced by about 20% as compared with the leakage magnetic field intensity of a one-stage tapered shield layer.

FIG. 9 illustrates a simulation result indicating the magnetic field intensity ratio B_{Sr} at the corner A_{R} when the external angle θ_{B}=110° and the external angle θ_{A} is changed. Here, the definition of the magnetic field intensity ratio B_{Sr} is the same as that illustrated in FIG. 8. The leakage magnetic field intensity of the shield layer having an external angle θ_{A} of 3° to 15° is reduced by an amount more than or equal to 10% as compared with the leakage magnetic field intensity of a magnetic head including a one-stage tapered shield layer. The leakage magnetic field intensity of the shield layer having an external angle θ_{A} of 4° to 12° is reduced by an amount more than or equal to 15% as compared with the leakage magnetic field intensity of a one-stage tapered shield layer. In particular, the leakage magnetic field intensity of the shield layer having an external angle θ_{A} of 6° to 10° is reduced by an amount more than or equal to 20% as compared with the leakage magnetic field intensity of a one-stage tapered shield layer.

The dimensions of the shield layer are not limited to particular values. In typical shield layers and auxiliary magnetic pole layers, a width W_{A} of the floating surface 20 is in the range of 20 to 60 μm, the distance between the corners B_{L} and B_{R} is in the range of 60 to 95 μm, and the distance L between the floating surface 20 and the height surface 21 is in the range of 25 to 40 μm. For a trailing shield layer, in general, a width W_{A} of the floating surface 20 is in the range of 20 to 60 μm, the distance between the corners B_{L} and B_{R} is in the range of 60 to 95 μm, and the distance L between the floating surface 20 and the height surface 21 is in the range of 4 to 10 μm.

An example of the dimensions of the shield layers is described below.

In the lower shield layer 3 and the upper shield layer 6 having the shape as illustrated in FIG. 2 when viewed from the layer direction of a substrate, a width W_{A} of the floating surface 20 is 30.0 μm. A distance W_{AR} between the corner A_{R} and an intersecting point B_{R}′ at which a perpendicular line dropped from the corner B_{R} intersects the floating surface 20 is 15.0 μm. A distance W_{AL} between the corner A_{L} and an intersecting point B_{L}′ at which a perpendicular line dropped from, the corner B_{L} intersects the floating surface 20 is 15.0 μm. A distance L between the floating surface 20 and the height surface 21 is 37.0 μm.

In the return yoke layer 9 having the shape as illustrated in FIG. 2 when viewed from the layer direction of a substrate, a width W_{A} of the floating surface 20 is 26.0 μm. A distance W_{AR} between the corner A_{R} and an intersecting point B_{R}′ at which a perpendicular line dropped from the corner B_{R} intersects the floating surface 20 is 15.0 μm. A distance W_{AL} between the corner A_{L} and an intersecting point B_{L}′ at which a perpendicular line dropped from the corner B_{L} intersects the floating surface 20 is 15.0 μm. A distance L between the floating surface 20 and the height surface 21 is 35.0 μm.

In the return yoke layer 15, a width W_{A} of the floating surface 20 is 26.0 μm. A distance W_{AR} between the corner A_{R} and an intersecting point B_{R}′ at which a perpendicular line dropped from the corner B_{R} intersects the floating surface 20 is 15.0 μm. A distance W_{AL} between the corner A_{L} and an intersecting point B_{L}′ at which a perpendicular line dropped from the corner B_{L} intersects the floating surface 20 is 15.0 μm. A distance L between the floating surface 20 and the height surface 21 is 35.0 μm.

In the trailing shield layer 14 having the shape as illustrated in FIG. 11 when viewed from the layer direction of a substrate, a width W_{A} of the floating surface 20 is 24.0 μm. A distance W_{AR} between the corner A_{R} and an intersecting point B_{R}′ at which a perpendicular line dropped from the corner BR intersects the floating surface 20 is 15.0 μm. A distance W_{AL} between the corner A_{L} and an intersecting point B_{L}′ at which a perpendicular line dropped from the corner B_{L} intersects the floating surface 20 is 15.0 μm. A distance L between the floating surface 20 and the height surface 21 is 5.0 μm. In addition, the distance between the corner C₂ and the corner C₃ is 18.0 μm. The length L_{CH1} of a perpendicular line extending from the corner C₂ to the height surface 21 is 4.85 μm. The length L_{CH2} of a perpendicular line extending from the corner C₃ to the height surface 21 is 4.85 μm. A distance L_{CW1} between the corner C₁ and an intersecting point at which a perpendicular line extending from the corner C₂ intersects the height surface 21 is 12.0 μm. A distance L_{CW2} between the corner C₄ and an intersecting point at which a perpendicular line extending from the corner C₃ intersects the height surface 21 is 12.0 μm.

FIGS. 8 and 9 illustrate the result of simulation performed for the shield layer and the auxiliary magnetic pole layer having the above-described dimensions.

As a distance L_{1R} between the corner B_{R} and the floating surface 20 and a distance L_{1L} between the corner B_{L} and the floating surface 20 (hereinafter collectively referred to as a “distance L₁”) is decreased to zero, the occurrence of an edge writing problem caused by a magnetic flax concentrated on the corners B_{R} and B_{L} from the soft magnetic underlayer increases. The simulation result illustrated in FIG. 8 indicates that the occurrence of an edge writing problem is rare when the external angle θ_{A} is greater than or equal to 3°, that, is, when the distance L₁ is greater than or equal to 0.8 μm. In contrast, when the distance L₁ is less than 0.8 μm, the edge writing problem often occurs, since the leakage magnetic field is large.

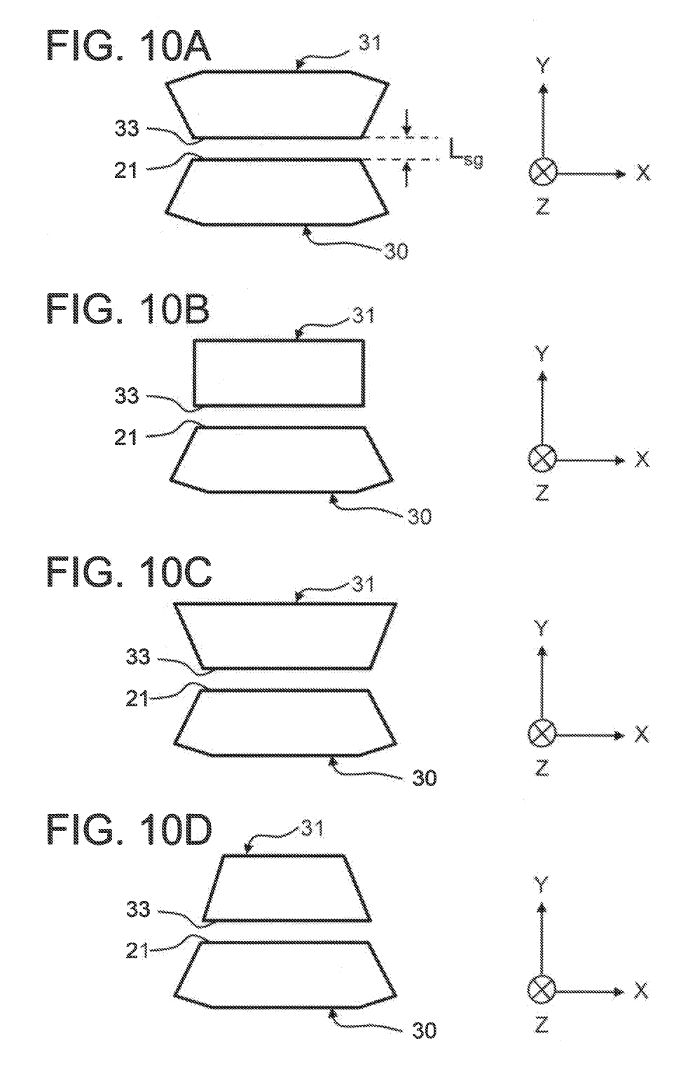

FIGS. 10A to 10D are schematic illustrations of example applications of the shield when viewed in a direction in which the layers are stacked on a substrate.

In a shield illustrated in FIG. 10A, an auxiliary shield layer 31 is disposed on the height side of a shield layer 30 illustrated in FIG. 2 with a predetermined spacing therebetween. In a typical case, a height surface 21 of the shield layer 30 is parallel to an end surface 33 of the auxiliary shield layer 31 on the floating surface side. In general, the length of the shield layer in the height direction tends to be increased in order to prevent an external magnetic field from concentratingly entering the main magnetic pole layer and the MR element. However, a shield layer having a large length in the height direction easily absorbs a stray magnetic field in the magnetic head, and therefore, an edge writing problem often occurs. By absorbing the magnetic flux using the auxiliary shield layer disposed on the height side of the shield layer, an amount of the magnetic flux entering through the floating surface of the shield layer can be appropriately controlled. Thus, the occurrence of the edge writing problem caused by the magnetic flux concentrated on the corner of the shield layer on the floating surface side from the soft magnetic underlayer of a recording medium can be reduced.

Any shape can be employed for the auxiliary shield layer. For example, an auxiliary shield layer 31 illustrated in FIG. 10A has a shape that is the same as that of the shield layer 30. In addition, the auxiliary shield layer 31 is disposed so as not to face a plane recording medium of the auxiliary shield layer 31 corresponding to the first surface and the second surface of the shield layer 30. Alternatively, the auxiliary shield layer having a shape of a square (refer to FIG. 10B), an inverted trapezoid (refer to FIG. 10C), or a trapezoid (refer to FIG. 10D) can be employed.

It is desirable that a distance L_{sg} between the shield layer 30 and the auxiliary shield layer 31 is in the range of 0.1 to 10 μm. The distance L_{sg} in such a range can effectively prevent a magnetic flux from entering the shield layer from the auxiliary shield layer, and therefore, the occurrence of the edge writing problem can be reduced. If the distance L_{sg} is greater than 10 μm, the shield layers cannot sufficiently cover the MR element and the main magnetic pole layer. Thus, a resistance to an external magnetic field of the MR element and the main magnetic pole layer deteriorates.

According to the magnetic head of the foregoing embodiments, a magnetic flux concentrates on a corner portion of the shield layer or the auxiliary magnetic pole layer that is distant from the facing surface of a recording medium. Accordingly, the magnetic flux does not concentrate on a corner potion closest to the facing surface of the recording medium. As a result, the occurrence of an edge writing problem can be effectively reduced.

While the present invention has been described with reference to the foregoing embodiments, it should be understood by those skilled in the art that various modifications, combinations, sub-combinations and alterations may occur depending on design requirements and other factors insofar as they are within the scope of the appended claims or the equivalents thereof.

What is claimed is:

1. A magnetic head for recording information on a recording medium comprising:
a magnetic pole layer having an end face to be facing the recording medium;
an auxiliary magnetic pole layer magnetically connected to the magnetic pole; and
a shield layer for shielding the magnetic pole layer from an external magnetic field, the shield layer having a first surface to foe facing the recording medium, a second surface to he facing the recording medium adjacent to the first surface, and a third surface adjacent to the second surface, the first surface and the second surface forming an acute external angle, the first surface and the third surface forming an obtuse external angle.

2. The magnetic head according to claim 1, wherein the second surface and the third surface form an acute internal angle.

3. The magnetic head according to claim 1, wherein the first surface and second surface form an external angle from 3 to 15 degrees, and the first surface and second surface form an external angle from 105 to 135 degrees.

4. The magnetic head according to claim 1, wherein a distance from intersections of the second surface and the third surface to the first surface is equal to 0.8 micrometers or greater.

5. A magnetic head for reproducing information recorded on a recording medium comprising:
a magneto-resistive element for reproducing information, and
a shield layer for shielding the magneto-resistive element from an external magnetic field, the shield layer having a first surface to be facing the recording medium, a second surface to be facing the recording medium adjacent to the first surface, and a third surface adjacent to the second surface, the first surface and the second surface forming an acute external angle, the first surface and the third surface forming an obtuse external angle.

6. The magnetic head according to claim 5, wherein the second surface and the third surface form an acute internal angle.

7. The magnetic head according to claim 5, wherein the first surface and second surface form an external angle from 3 to 15 degrees, and the first surface and second surface form a external angle from 105 to 135 degrees.

8. The magnetic head according to claim 5, wherein a distance from intersections of the second surface and the third surface to the first surface is equal to 0.8 micrometers or greater.

9. The magnetic head according to claim 5, further comprising:
an auxiliary shield layer upper than the shield layer on a basis of the recording medium, the auxiliary shield layer being apart from the shield layer.

10. The magnetic head according to claim 1, further comprising:
a magneto-resistive element for reproducing information recorded on the recording medium, and
a shield layer for shielding the magneto-resistive element from an external magnetic field, the shield layer having a first surface to foe facing the recording medium, a second surface to foe facing the recording medium adjacent to the first surface, and a third surface adjacent to the second surface, the first surface and the second surface forming an acute external angle, the first surface and the third surface forming an obtuse external angle.

11. A magnetic head for recording information on a recording medium comprising:
a magnetic pole layer having an end face to be facing the recording medium;
an auxiliary magnetic pole layer magnetically connected to the magnetic pole, the auxiliary magnetic pole layer having a first surface to be facing the recording medium, a second surface to be facing the recording medium adjacent to the first surface, and a third surface adjacent to the second surface, the first surface and the second surface forming an acute external angle, the first surface and the third surface forming an obtuse external angle.

12. The magnetic head according to claim 11, wherein the first surface and the second surface form an acute internal angle.

13. The magnetic head according to claim 11, wherein the first surface and the second surface form an external angle from 3 to 15 degrees, and the first surface and the third surface form an external angle from 105 to 135 degrees.

14. The magnetic head according to claim 11, wherein a distance from intersections of the second surface and the third surface to the first surface is equal to 0.8 micrometers or greater.

15. The magnetic head according to claim 1, wherein the auxiliary magnetic pole layer has a first surface to be facing the recording medium, a second surface to be facing the recording medium adjacent to the first surface, and a third surface adjacent to the second surface, the first surface and the second surface forming an acute external angle, the first surface and the third surface forming an obtuse external angle.

16. The magnetic head according to claim 5, further comprising:
a magnetic pole layer having an end face to be facing the recording medium for recording information on the recording medium;
an auxiliary magnetic pole layer connected to the magnetic pole, the auxiliary magnetic pole layer having a first surface to be facing the recording medium, a second surface to be facing the recording medium adjacent to the first surface, and a third surface adjacent to the second surface, the first surface and the second surface forming an acute external angle, the first surface and the third surface forming an obtuse external angle.

17. The magnetic head according to claim 10, wherein the auxiliary magnetic pole layer has a first surface to be facing the recording medium, a second surface to be facing the recording medium adjacent to the first surface, and a third surface adjacent to the second surface, the first surface and the second surface forming an acute external angle, the first surface and the third surface forming an obtuse external angle.
